(19) United States
(12) Patent Application Publication
(10) Pub. No.: US 2008/0057480 A1
(43) Pub. Date: Mar. 6, 2008

(54) Multimedia system and method for teaching basal math and science

(75) Inventors: Ronald Packard, McLean, VA (US); Bror V. Saxberg, Beverly Hills, CA (US)

Correspondence Address: VENABLE LLP, P.O. BOX 34385, WASHINGTON, DC, 20043-9998, US

(73) Assignee: K12 Inc., Herndon, VA (US)

(21) Appl. No.: 11/896,484

(22) Filed: Aug. 31, 2007

Related U.S. Application Data
(60) Provisional application No. 60/841,686, filed on Sep. 1, 2006.

(51) Int. Cl. G09B 23/02

(52) U.S. Cl. 434/188

(57) ABSTRACT

A computer-implemented method for teaching basal math and science may include: testing a student with a computerized test to produce a completed test; scoring the completed test on a computer to produce a score; determining a grade level for the student based on the score; generating a weak areas assessment for the student based on the completed test; and generating a computer-based individualized learning plan based on the determined grade level, a curriculum, and the weak areas assessment. The method may further include providing computerized coursework to a student based on the individualized learning plan.

### CROSS-REFERENCE TO RELATED PATENT APPLICATION

This application is a Non-Provisional U.S. Application claiming the benefit of U.S. Provisional Patent Application No. 60/841,686, filed Sep. 1, 2006, by Packard et al, entitled “Multimedia System and Method for Teaching Basal Math and Science”, of common assignee to the present invention, the contents of which are incorporated herein by reference in their entirety.

### BACKGROUND

Students, particularly kindergarten and elementary students, are in their formative years, and rely upon skilled teachers to teach them the basic skills and concepts in such courses as language, mathematics, science, and writing. Heretofore, math and science skills have been taught in the traditional classroom with a student's textbook being the primary focus of such skills development.

Students within a single class may traditionally be taught based on the same curriculum, using the same textbook, coursework, and other materials. This may simplify the job of the teacher, as only one curriculum needs to be followed and all students can be taught at the same time, but it may also not teach all students effectively. Students who are the same age and therefore in the same grade and same class, may have varying levels of previous education in a particular subject, and may have different strengths and weaknesses within any given subject. A traditional classroom course may not take any of this into account when setting an individualized learning plan to be followed by every student in a class.

Individualized learning plans are known in the realm of special education, for students with learning or developmental disabilities. However, students in traditional class settings are expected to follow the curriculum set for the whole class.

It has been found, however, that children in kindergarten and elementary schools might benefit from a greatly enhanced, interactive learning environment, which uses flip books and student books, but focuses their teaching with interactive tools. Further, more students are being taught in non-traditional settings, such as distance learning and home schooling environments. Students in both traditional and non-traditional learning settings may benefit from a system and method of teaching math and/or science that is tailored to the student's needs and learning environment.

### SUMMARY OF THE INVENTION

One embodiment includes a computer-implemented method for teaching basal math and science comprising: testing a student with a computerized test to produce a completed test; scoring the completed test on a computer to produce a score; determining a grade level for the student based on the score; generating a weak areas assessment for the student based on the completed test; and generating a computer-based individualized learning plan based on the determined grade level, a curriculum, and the weak areas assessment.

The method may further include providing computerized coursework based on the individualized learning plan; monitoring the computerized coursework to detect events; and at least one of: generating alerts based on detected events, or automatically modifying the individualized learning plan based on the detected events.

Monitoring to detect events may include monitoring for at least one of: a completed lesson, an over-due lesson, a low score, a high score, or a lesson completed before a due date.

Providing computerized coursework comprises providing computerized coursework in a classroom, in a virtual learning environment, and/or a hybrid learning environment.

The method may further include receiving modifications to the individualized learning plan from a user.

The computerized test may include at least two sub-topics, and scoring the computerized test may include scoring each sub-topic separately. Generating a weak areas assessment may include generating the weak areas assessment for each sub-topic based on a sub-topic score.

The method may further include storing at least one of the completed test, the score, the grade level or the weak areas assessment on a computer-readable medium.

The computer-based individualized learning plan may be based on one of a math curriculum or a science curriculum.

In another embodiment, the invention may be a system for teaching basal math and science comprising: a testing station to administer a computerized test and produce a completed test; a scoring engine to receive the completed test and generate and transmit test results; a test analyzing engine to receive the test results and generate and transmit a grade level and a weak areas assessment; a coursework database comprising a plurality of lessons; and an individualized learning plan (ILP) generating engine to receive the grade level and the weak areas assessment, access the coursework database, and generate an ILP comprising a plurality of the lessons.

The system may further include a server comprising student records, wherein the student records comprise an individualized learning plan; a student computer adapted to access the server; and a responsible party computer adapted to access the server.

The server may include an event monitor adapted to monitor the individualized learning plan, the student computer, and the responsible party computer to detect events, and generate alerts based on detected events. The server may include a learning environment application, including: a curriculum planner to view and access lessons in the individualized learning plan; a progress tracker to view and track at least one of a student or a class's progress through one or more individualized learning plans; and a user interface to provide access to the curriculum planner and the progress tracker.

In another embodiment, the invention may be a computer-readable medium comprising instructions, which when executed by a computer system causes the computer system to perform operations for creating an individualized learning plan for a math or science curriculum, the medium comprising: instructions for testing a student with a computerized test to produce a completed test; instructions for scoring the completed test on a computer to produce a score; instructions for determining a grade level for the student based on the score; instructions for generating a weak areas assessment for the student based on the completed test; and instructions for generating a computer-based individualized learning plan based on the determined grade level, a curriculum, and the weak areas assessment.

The computer-readable medium may further include instructions for providing computerized coursework based on the individualized learning plan; instructions for monitoring the computerized coursework to detect events; and instructions for at least one of: generating alerts based on detected events, or automatically modifying the individualized learning plan based on the detected events.

The instructions for monitoring to detect events may include instructions for monitoring for at least one of: a completed lesson, an over-due lesson, a low score, a high score, or a lesson completed before a due date.

The instructions for providing computerized coursework may include instructions for providing computerized coursework in a classroom, a hybrid learning environment, or a virtual learning environment.

The computer-readable medium may further include instructions for receiving modifications to the individualized learning plan from a user.

The computerized test may include at least two sub-topics, and the instructions for scoring the computerized test to produce a score may include instructions for scoring each sub-topic separately.

The instructions for generating a weak areas assessment comprise instructions for generating the weak areas assessment for each sub-topic based on a sub-topic score.

The computer-readable medium may further include instructions for storing at least one of the completed test, the score, the grade level or the weak areas assessment on a computer-readable medium.

Further features of the invention, as well as the structure and operation of various embodiments of the invention, are described in detail below with reference to the accompanying drawings.

### BRIEF DESCRIPTION OF THE DRAWINGS

Embodiments of the invention will now be described in connection with the associated drawings, in which:

FIG. 1 depicts an exemplary system for generating an individualized learning plan for teaching basal math and science.

FIG. 2 depicts an exemplary flowchart for a method for generating an individualized learning plan for teaching basal math and science.

FIG. 3 depicts an exemplary embodiment of individualized learning plan (ILP) 111 an individualized learning plan.

FIG. 4 depicts an exemplary system for teaching basal math and science.

FIG. 5 depicts an exemplary embodiment of student records.

FIG. 6 depicts an exemplary flowchart for a method for teaching basal math and science.

FIG. 7 depicts an exemplary flow chart for block 608 of FIG. 6.

FIG. 8 depicts an exemplary embodiment of a system for accessing server 402.

FIG. 9 depicts an exemplary display for curriculum planner 812.

FIG. 10 depicts an exemplary display for progress tracker 816.

FIG. 11 depicts an exemplary architecture for implementing a computer 1101 that may be the student computer 401 and responsible party computer 404.

### DEFINITIONS

In describing the invention, the following definitions are applicable throughout (including above).

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, or a chip set; a system-on-chip (SoC) or a multiprocessor system-on-chip (MPSoC); an optical computer; a quantum computer; a biological computer; and an apparatus that may accept data, may process data in accordance with one or more stored software programs, may generate results, and typically may include input, output, storage, arithmetic, logic, and control units.

“Software” may refer to prescribed rules to operate a computer or a portion of a computer. Examples of software may include: code segments; instructions; applets; pre-compiled code; compiled code; interpreted code; computer programs; and programmed logic.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a memory chip; and/or other types of media that can store data, software, and other machine-readable instructions thereon.

A “computer system” may refer to a system having one or more computers, where each computer may include a computer-readable medium embodying software to operate the computer. Examples of a computer system may include: a distributed computer system for processing information via computer systems linked by a network; two or more computer systems connected together via a network for transmitting and/or receiving information between the computer systems; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those that may be made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet. Exemplary networks may operate with any of a number of protocols, such as Internet protocol (IP), asynchronous transfer mode (ATM), and/or synchronous optical network (SONET), user datagram protocol (UDP), IEEE 802.x, etc.

### DETAILED DESCRIPTION OF EMBODIMENTS OF THE PRESENT INVENTION

Exemplary embodiments of the invention are discussed in detail below. While specific exemplary embodiments are discussed, it should be understood that this is done for illustration purposes only. In describing and illustrating the exemplary embodiments, specific terminology is employed for the sake of clarity. However, the invention is not intended to be limited to the specific terminology so selected. A person skilled in the relevant art will recognize that other components and configurations may be used without parting from the spirit and scope of the invention. It is to be understood that each specific element includes all technical equivalents that operate in a similar manner to accomplish a similar purpose. The examples and embodiments described herein are non-limiting examples.

In an exemplary embodiment, an individualized learning plan for a student may be generated based on test results from a computerized test and in conjunction with a basal math and/or science curriculum. The individualized learning plan may be used to teach a student basal math and/or science. A basal curriculum may be for a full-semester, trimester, or year course in the subject of math or science,. The computerized test may address any math or science subject area, and may be designed to assess a student's proficiency in that subject area. The student may take the test on a testing device, and once completed, the test may be scored electronically, producing the test results. The test results may by analyzed to determine a grade level for the student in the subject area of the test, and to provide a diagnostic assessment, including areas in which the students is already proficient, and areas in which the student is weak, which may include topics within the subject area of the test in which the student may benefit from remediation. The grade level and the weak areas assessment may be used to generate an individualized learning plan (ILP), which may outline an entire semester or year's worth of coursework for the student in the subject area of the test.

The individualized learning plan may then be used by a responsible party, for example, a teacher or a parent, to teach the student in the subject area of the test. The student may complete coursework on a computer, and the student's progress may be monitored based on the coursework. Alerts may be generated and sent out to the responsible party, or to any other responsible party, when an event is detected during the monitoring of the student's coursework. An event may be, for example, the student's average score for coursework falling below a certain level, or rising above a certain level. The responsible party may access and change the ILP at any time, including, for example, in response to receiving alerts. The ILP may also be changed automatically in response to the detection of events.

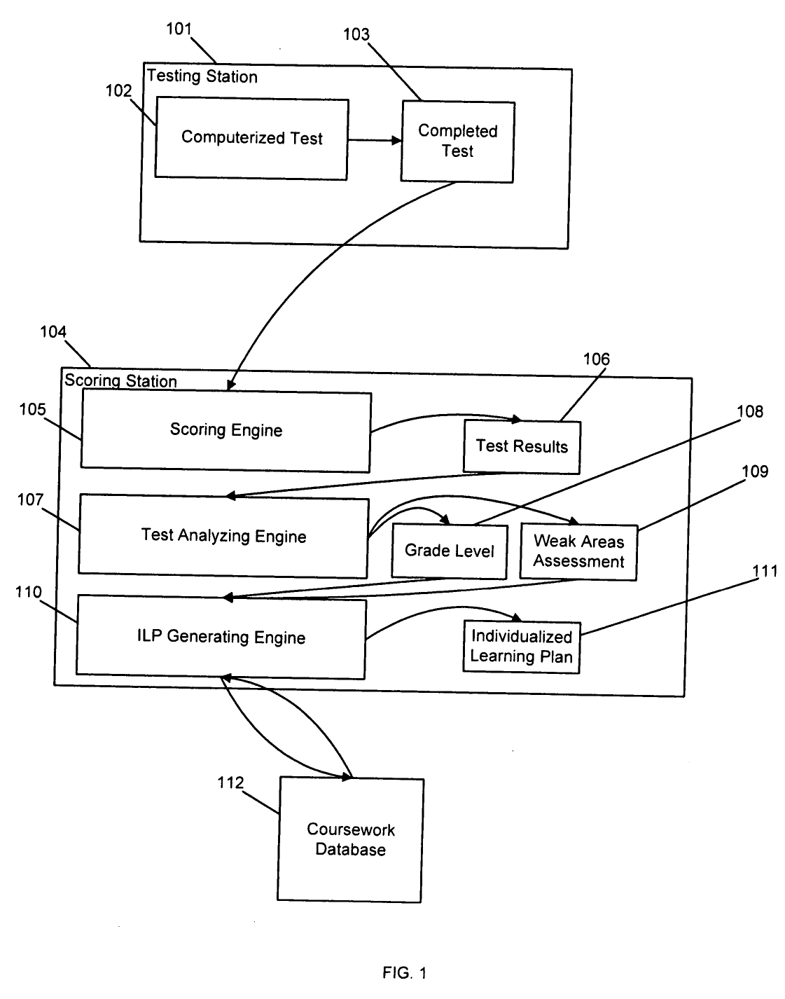

FIG. 1 depicts an exemplary system for generating an individualized learning plan for teaching basal math and/or science. A computer testing station 101 may contain a computerized test 102. Testing station 101 may be part of, or in communication with, a virtual learning environment, such as an online learning center, or a hybrid learning environment.

Computerized test 102 may be a test in one or more subject areas that may be accessed by and completed on testing station 101. Computerized test 102 may contain one or more test questions of a type suitable for testing student knowledge and proficiency in the subject area or areas being tested. For example, computerized test 102 may contain multiple choice questions, or short answer questions. Computerized test 102 may have additional test parameters, for example, a time limit for all of the test questions, a time limit for individual test questions, or a limit on the number of times an answer to a test question can be changed. Computerized test 102 may be divided into any number of sections, which may be representative of distinct topics or core concepts within a subject area, or may be grouped based on any other criteria. Answers to each of the test questions on computerized test 102 may be entered into testing station 101 by the student. When computerized test 102 has been finished, completed test 103 may be produced.

Completed test 103 may include the answers entered by the student to the test questions of computerized test 102, and may also include any other information pertaining to the completion of computerized test 102 by the student. For example, completed test 103 may contain data indicating the amount of time the student took to complete computerized test 102, the amount of time the student spent answering each question, the number of times the student changed the answer given for each question and what the answers were changed from, etc. Completed test 103 may be in a form suitable for scoring by a scoring station 104, and may be stored on a computer-readable medium accessible to testing station 101. When the completed test 103 has been generated by testing station 101, the completed test 103 may be transmitted to the scoring station 104. Completed test 103 may be stored on and retrieved from a computer-readable medium accessible to testing station 101 and/or scoring station 104.

Scoring station 104 may include software and/or hardware modules, including a scoring engine 105, a test analyzing engine 107, and an individualized learning plan (ILP) generating engine 110. Scoring engine 105 may be software and/or hardware that scores the completed test 103 to generate the test results 106. The test analyzing engine 107 may be software and/or hardware that analyzes the test results 106 to produce a grade level 108 and a weak areas assessment 109. ILP generating engine 110 may be an software and/or hardware that generates an individualized learning plan 111 based on a curriculum, a grade level, and a weak area assessment. Test results 106, grade level 108, weak areas assessment 109, and individual learning plan 111 may be stored on any computer readable medium accessible to testing analysis station 104.

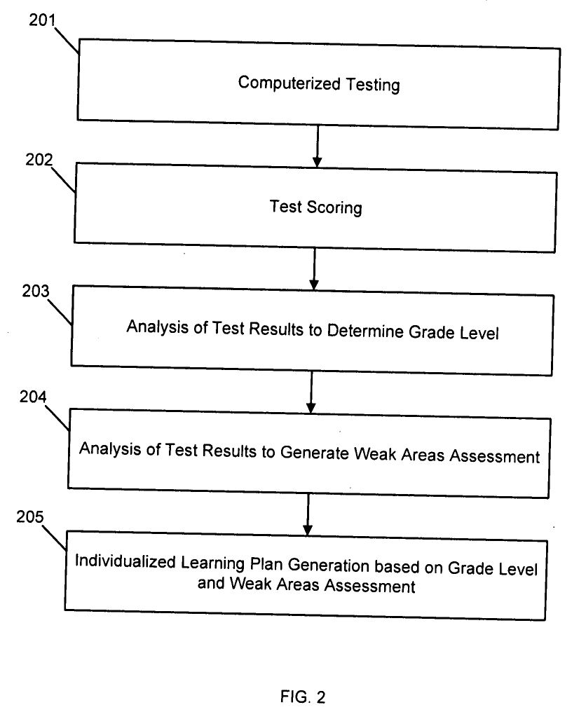

Scoring station 104 may be run on a computer separate from testing station 101, or may be run on the same device as testing station 101. The functionality of the modules of scoring station 104 is discussed further below with respect to FIG. 2.

FIG. 2 depicts an exemplary flowchart for a method for teaching basal math and science, and is discussed in relation to FIG. 1. In block 201, a student may take computerized test 102 in one or more subject areas. Computerized test 102 may be taken by the student on any suitable computer or other electronic device in, for example, a classroom, at home, or in any other location. When the student has completed computerized test 102, either by entering answers to all the questions, allowing the time limit to lapse, or indicating in any suitable manner that they are finished taking computerized test 102, the result is completed test 103.

In block 202, completed test 103 may be scored by scoring engine 105 to produce test results 106. Scoring may be performed by any scoring method suitable for the computerized test 102 and the information contained in completed test 103. For example, a raw score may be calculated by scoring engine 105. The raw score may be a count of right and wrong answers in the completed test 103, and may be converted to a final score or a scaled score based on various criteria, for example, a scaling system established for computerized test 102. Scoring may incorporate other information in the completed test 103, for example, the amount of time taken to complete the computerized test 102. Scoring may also calculate scores for specific topics or concepts tested, for example, in an arithmetic test, a student may be tested and scored separately on adding single-digit numbers and adding double-digit numbers.

Scoring may be done on the same computer or computing device on which computerized test 102 was taken if, for example, testing station 101 and scoring station 104 are on the same computer. Alternatively, testing and scoring may take place on separate computers or electronic devices if, for example, testing station 101 and testing analysis station 104 are on separate computers.

For example, if testing station 101 is a thin client in a classroom and testing analysis station 104 is on a server located elsewhere, completed test 103 may be transmitted over a network to the server, and the server may score completed test 103 and transmit test results 106 back to the thin client, where they may be viewed by the student. After the server has received completed test 103 from the thin client and scored completed test 103, the server may transmit completed test 103 and test results 106 to a second server, on which completed test 103 and test results 106 may be stored on computer-readable medium containing a student records database.

In block 203, completed test 103 and test results 106 may be analyzed test analyzing engine 107 to determine grade level 108 for the student. Grade level 108 may be determined through analysis of completed test 103 and test results 106, and in conjunction with a standard curriculum (not shown). Grade level 108 may be data indicating the grade level of student's knowledge and abilities in the subject area of computerized test 102, based on any suitable set of academic standards for each of the grade levels in a school, and may be used to determine the coursework appropriate for the student with that subject area. A student assessed to be at a grade level 108 lower than the grade level for their age may not have obtained the level of knowledge and abilities in the subject area of computerized test 102 according to relevant academic standards.

In an exemplary embodiment, test analyzing engine 107 may determine grade level 108 by, for example, correlating different percentages of correct answers on a multiple-choice test with different grade levels. For example, if a multiple-choice test in science has 100 questions, answering 91% of the questions correctly may correlate with a grade level of 8, answering 80% to 90% may correlate with a grade level of 7, and so on.

Alternatively, test analyzing engine 107 may compare results on a subtopic, concept or subject area within the test to the curriculum, to determine the extent to which the student has completed, or is proficient in, portions of the curriculum.

In block 204, completed test 103 and test results 106 may be analyzed to generate weak areas assessment 109. Weak areas assessment 108 may be determined by test analyzing engine 107 through analysis of completed test 103 and test results 106. Whether or not a subtopic of computerized test 102 is a weak area for the student may be determined based on various metrics for judging a student's performance in specific subtopics or areas within the subject area of computerized test 102, including, for example, number of correctly answered questions within the subtopic, time taken to complete the questions within the subtopic, etc.

For example, different percentages of correct answers on a multiple-choice test within a subtopic or area may be used to determine how weak a student is within that subtopic or area. If a multiple-choice test in science has 20 questions on Newtonian physics, answering 5 or fewer of the questions correctly may indicate a very weak subtopic, 6-10 correctly answered questions may indicate a weak subtopic, 11-15 correctly answered questions may indicate an average subtopic, and 16-20 may indicate a strong subtopic.

Each subtopic contained within the subject area of, and tested on, computerized test 102 may be analyzed by test analysis engine 107 to determine the strength or weakness of the student in that subtopic. The results for all of the subtopics may be combined to generate the weak areas assessment 109.

In block 205, individualized learning plan (ILP) 111 may be generated based on grade level 108 and weak areas assessment 109, by ILP generating engine 110. ILP generating engine 110 may use grade level 108 to determine which lessons and/or units from a coursework database 112 to place on ILP 111. For example, if grade level 108 is 8^{th} grade, ILP generating engine 110 may schedule lessons from 8^{th} grade from the coursework database 112 on ILP 111. Weak areas assessment 109 may be used by ILP generating engine 110 in determining what lessons to place on ILP 111, and how to schedule the lessons placed on ILP 111. For example, if weak areas assessment 109 indicates that in the subject area of math, fractions are a very weak subtopic, ILP generating engine 110 may place on ILP 111 lessons designed for remedial teaching of fractions, or more instances of lessons focused on fractions, and/or allow for longer amounts of time between the assignment and due dates of lessons dealing with fractions. ILP 111 may provide remediation in subtopics identified as weak areas in weak areas assessment 109 while providing grade level appropriate lessons in other subtopics as determined by grade level 108.

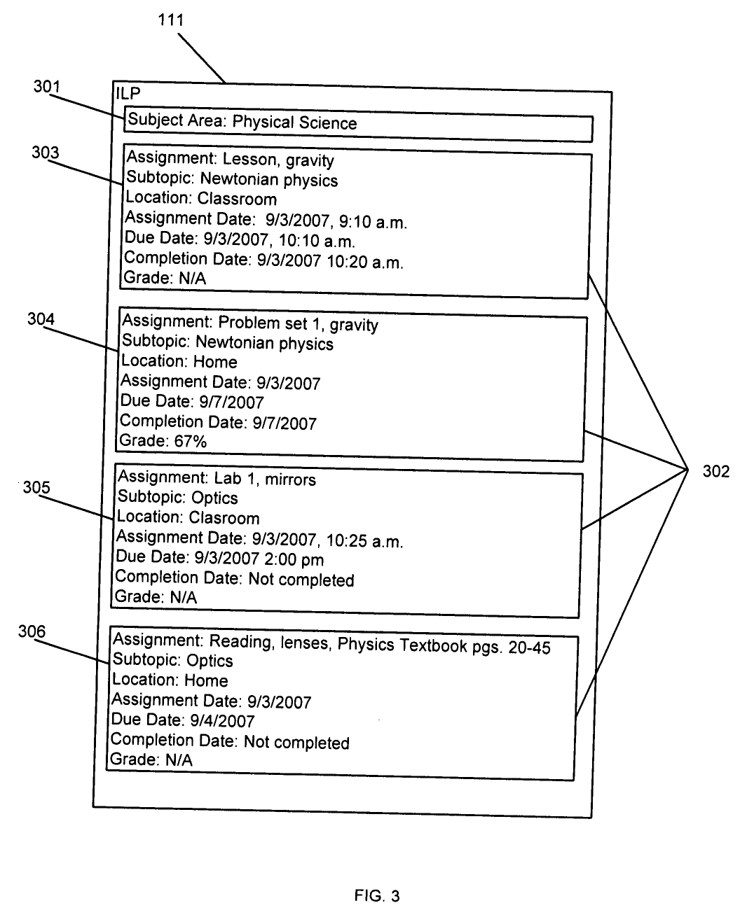

As shown in FIG. 3, ILP 111 may include a listing of lessons 303, 304, 305, 306 (collectively, lessons 302) to be completed, including tests to be taken, lessons to be given, classroom sessions to be attended, and so on. Any relevant aspect of an educational experience may be included in ILP 111 as one of the lessons 302. ILP 111 may define a course, i.e. the first of the lessons 302 on ILP 111 may indicate the beginning of the course, and the last of the lessons 302 on ILP 111 may indicate the end of the course.

ILP 111 may include subject area 301. Subject area 301 may indicate the subject area of ILP 111, based on, for example, the subject area of computerized test 102 relevant to the ILP 111. For example, subject area 301 may be a science subject, or a math subject. ILP 111 may include lessons 302. Each of the lessons 302 on ILP 111 may be an instance of coursework to be completed during the course prescribed by ILP 111. Each of the lessons 302 may include, for example: an assignment description describing the nature of the work to be done for the lesson; a subtopic name describing a unit of subject area 301 that the assignment pertains to; a location, describing the location that the work for each of the lessons 302 should take place in; an assignment date and time, providing the date and time on which work should begin on each of the lessons 302; a due date and time, providing the date and time on which each of the lessons 302 should be completed; completion date, recording the date and time each of the lessons 302 is actually completed; and grade, indicating the grade received by the student on completed lessons 302.

Coursework database 112 may be a database containing data for any number of lessons 302 in any number of subjects at any number of grade levels. Lessons 302 in database 112 may include, for example, coursework similar to the exemplary lessons 303, 304, 305, and 306, as well as worksheets, problem sets, assigned readings, lesson notes or outlines, quizzes, tests, long term projects, in-class projects, videos, and any other similar coursework suitable for use in an educational environment. In addition to the properties of lessons 302 shown in FIG. 3, each of the lessons 302 in coursework database 112 may be classified by grade level. For example, a test may be classified as an 8^{th} grade math test on factoring. Grade level classifications from coursework database 112 may be used by curriculum generating engine 110 and grade level 108 in selecting appropriate lessons 302 to be placed on ILP 111. Once lessons 302 are placed on ILP 111, the grade level of lessons 302 may not appear on ILP 111. Coursework database 112 may contain lessons 302 in their entirety, for example, an entire problem set and answer key may be contained with coursework database 112, or relevant descriptions of lessons 302, for example, a description locating a problem set and answer key by textbook title and page number.

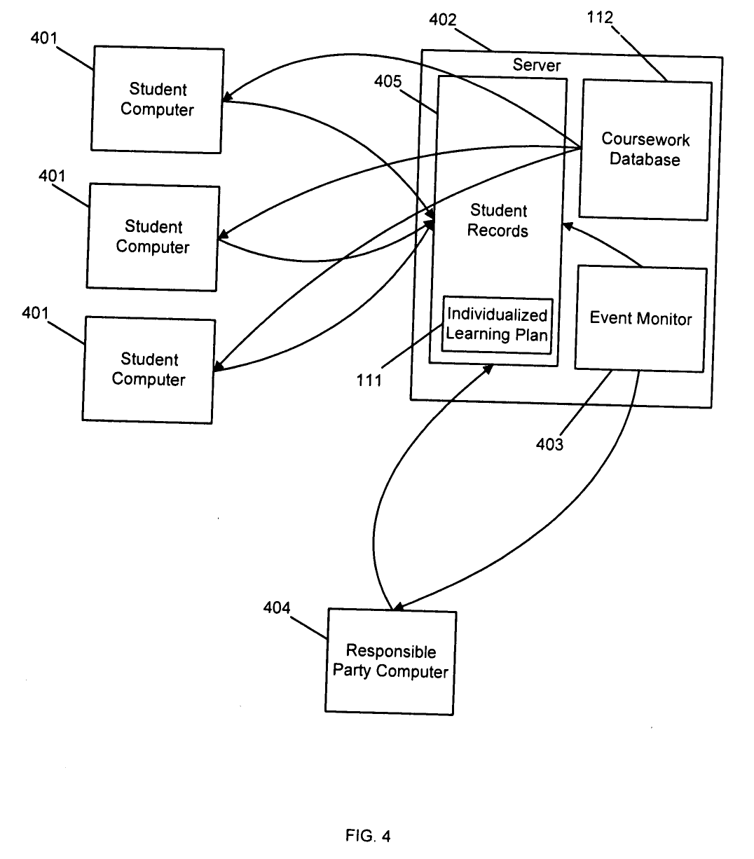

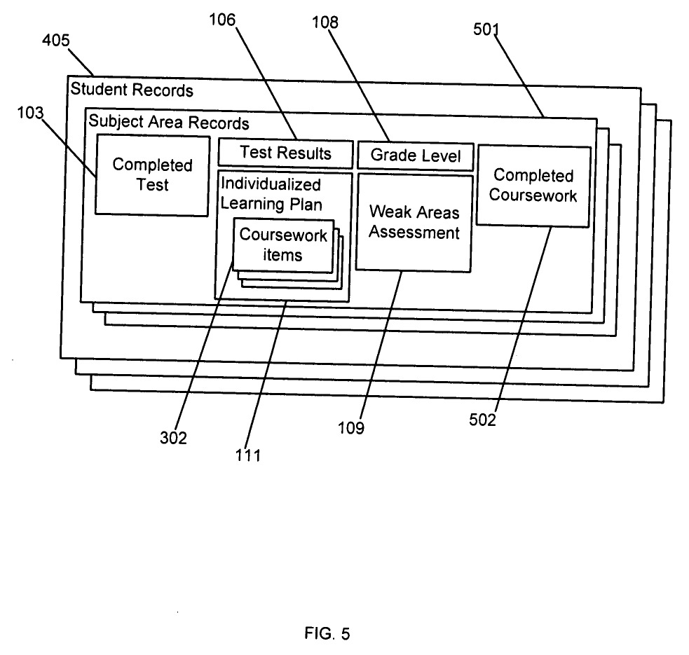

FIG. 4 depicts an exemplary system for teaching basal math and science and is discussed in relation to FIG. 1 and FIG. 2. FIG. 5 is an exemplary embodiment of student records 405. Student computer 401 may be any computer located, for example, in a classroom, in a student's home, or in a learning center of a hybrid learning environment. From student computer 401, a student may be able to access server 402, for example, over a network. The student may be able to view and complete coursework on ILP 111 from coursework database 112 on student computer 401. The lessons 302 the student is able to view from student computer 401 may be dependent on the physical location of student computer 401. For example, a student computer 401 located in a classroom area may be able to access coursework from coursework database 112 designated for classroom use only, for example, tests and quizzes. A student computer 401 located in the student's home may be able to access coursework from coursework database 112 designated only for home use, for example, homework problem sets. The location of student computer 401 may also affect the interface presented to the student for accessing and completing coursework from student computer 401. Student computer 401 may also serve as testing station 101.

Server 402 may be any computer, or more than one computer, for example, a server farm, in any location which may be accessed, for example, over a network. Student records 405 and coursework database 112 may be stored on server 402, or they may be stored on a computer readable medium accessible to server 402. Event monitor 403 may run on server 402. Student computer 401 and responsible party computer 404 may be able to access server 402, and through server 402 access student records 405 and coursework database 112. Server 402 may also serve as scoring station 104.

Student records 405 may be data pertaining to one or more students. Referring to FIG. 5, student records 405 for each student may contain subject area records 501 for each student in each subject area in which the student is being taught. For each subject area, subject area records 501 may contain completed test 103, test results 106, grade level 108, weak areas assessment 109, ILP 111, and completed coursework 502, for the student in the subject area. Each item in subject area records 501 may be stored on a computer readable medium as part of student records 405.

Completed coursework 502 may be one or more files containing either pointers to or complete lessons 302 from ILP 111 completed by the student on student computer 401. Completed coursework 502 may include completed worksheets, problem sets, tests, quizzes, or any other completed lessons 302 that may be sent to server 402. Each of the lessons 302 in completed coursework 502 may be graded or ungraded, depending on the nature of the lessons 302 on the ILP 111. Grades given to completed lessons 302 in completed coursework 502 may be stored in completed coursework 502, where they may be accessed, for example, to compile an overall grade for the course. Completed coursework 502 may be accessible by teacher computer 404 on server 402 as part of student records 405.

Referring back to FIG. 4, event monitor 403 may be software and/or hardware running on server 402 that may monitor the completion of coursework on ILP 111 by a student using student computer 401. Event monitor 403 may track any events relevant to the completion of coursework on ILP 111 by the student and teacher, including, for example, instances of the student accessing server 402 from student computer 401, when the student begins working on coursework, when the student submits coursework to server 402 as completed coursework 502, the level of performance the student has achieved on graded coursework, whether a teacher has presented an interactive lesson scheduled on ILP 111, whether a teacher has gone over the allotted amount of time in presenting an interactive lesson, etc. Event monitor 403 may further be programmed to generate an alert to a responsible party on the occurrence of certain events involving the student, including, for example, the student failing to submit coursework by a due date, the student failing to access an assigned reading far enough in advance of the due date for the student to complete the reading, the student submitting coursework in advance of a due date, the student receiving a low grade or a high grade on submitted coursework, the student's overall grade for the course dropping below or rising above a specified level, etc.

Event monitor 403 may also generate alerts based on the occurrence of certain events involving the teacher, including, for example, the teacher failing to present a scheduled lesson, the teacher going over the amount of time scheduled for presenting a lesson, etc. Event monitor 403 may also generate alerts when adjustments are made to ILP 111. When event monitor 403 detects such an event, event monitor 403 may generate an alert to a responsible party, for example, a teacher, parent, or guardian, by, for example, sending an email message from server 402 over the network to, for example, teacher computer 404. Alerts may be sent by any other suitable means, for example, as text or MMS messages, automated phone calls, via instant messaging services or network messaging services, etc.

Event monitor 403 may also make automatic changes to ILP 111 in response to detected events. For example, event monitor 403 may detect a student has completed one of the lessons 302 three days in advance of a due date, and may automatically adjust ILP 111 by moving a subsequent lessons 302 earlier by three days. As another example, event monitor 111 may detect that a student has achieved a high grade level on one of the lessons 302 in a subtopic of subject area 201, and may automatically remove further lessons 302 from that subtopic from ILP 111.

Responsible party computer 404 may be a computer or other electronic device belonging to a teacher, parent, guardian, or other party responsible for the student. Responsible party computer 404 may have access to server 402, and to student records 405 on server 402. Through the responsible party computer 404, all aspects of student records 405 may be accessed, including all subject area records 501 for each student, including completed test 103, test results 106, grade level 108, weak areas assessment 109, ILP 111, and completed coursework 502, if the party using responsible party computer 404 has permission. For example, a parent using responsible party computer 404 may only have permission to view student records 405 for the parent's own children who are students, and not student records 405 for any other students.

Responsible party computer 404 may also be used to make changes to ILP 111 in one of subject area records 501, if the responsible party using responsible party computer 404 has been granted permission to make such changes. For example, a science teacher may use responsible party computer 404 to make changes to ILP 111 if the ILP 111 is a science curriculum for a student taught by the science teacher, but may not make changes if the ILP 111 is a math curriculum. A parent who is not responsible for teaching may be able to use responsible party computer 404 to view ILP 111 in any one of subject area records 501 of student records 405 for their own children who are students, but not to make any changes to ILP 111.

Responsible party computer 404 may also receive alerts generated by event monitor 403. The type of alerts received by responsible party computer 404 may depend on the responsible party using the computer and may also depend on specific setting in event monitor 403. For example, event monitor 403 may be programmed to send alerts only to teachers when a student's overall grade has dropped below a specified level, but to send alerts to parents and teachers if the student fails to turn in coursework by a due date. If a teacher is using responsible party computer 404, the teacher may receive the alert from event monitor 403 that the student's grade has fallen below the specified level, and if a parent is using responsible party computer 404, the parent may not receive the alert from event monitor 403 that the student's grade has fallen below the specified level.

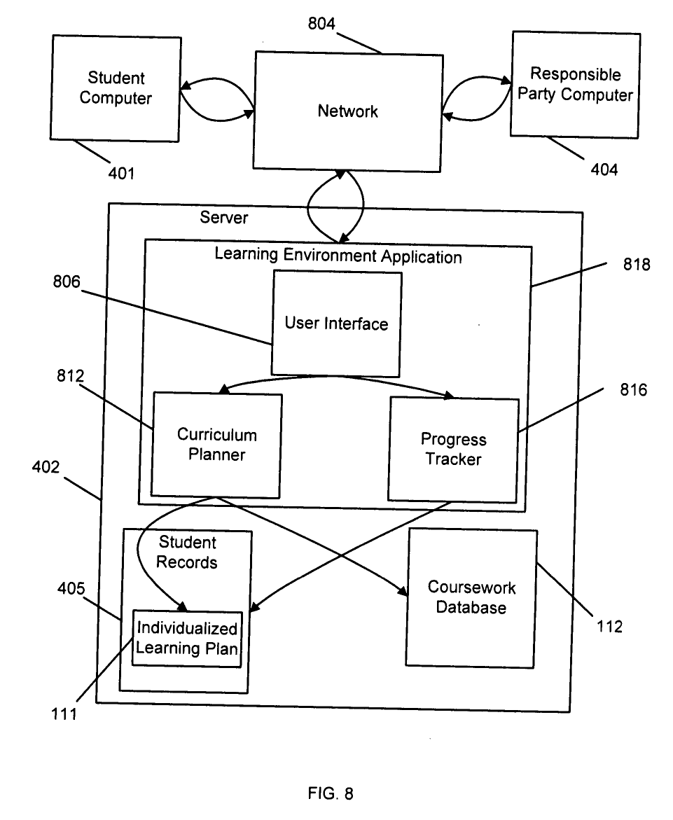

ILP 111 may be used in conjunction with the systems described above in FIG. 4 and in FIG. 8 to teach a course in basal math or science in various learning environments.

In a traditional classroom learning environment, both the teacher and the student may be in the same room, for example, a classroom, and most aspects of ILP 111, except for lessons 302 designated as homework, may be completed within the room. There may be one student computer 401 in the classroom along with responsible party computer 404, and a second computer 401 in the student's home. The teacher may use responsible party computer 404 to teach ILP 111 within the classroom, and the student may complete classroom lessons 302 on student computer 401 in the classroom. The ILP 111 may not have any lessons 302 requiring the teacher to provide any instructions, lessons and/or assistance to the student outside of the classroom using responsible party computer 404. The student may be expected to be in the classroom for a full day of instruction for every school day during the course of ILP 111.

A virtual learning environment may be a type of distance learning environment in which the student and the teacher or responsible party are never physically in the same room. In a virtual learning environment, student computer 401 and responsible party computer 404 are in different physical locations, and the teaching of ILP 111 may be accomplished through use of the connection between student computer 401, responsible party computer 404, and server 402. The student may use student computer 401 to complete all lessons 302 on ILP 111 and submit them to server 402, including receiving lessons, instructions and/or assistance from the teacher or responsible party. The teacher or responsible party may use responsible party computer 404 to accomplish all aspects of teaching ILP 111 to the student, including accessing completed lessons 302 from the student on server 402, and providing lessons, instructions, and or assistance to the student. The student may never be in the same room as the teacher or responsible party. For example, in order to complete one of the lessons 302 that is a lesson, a teacher may establish a one-way or two-way video connection between responsible party computer 404 and student computer 401, and the student may use student computer 401 to view and listen to the lesson. The lesson may be accompanied by, for example, slides, which may appear on student computer 402 along with the video.

A hybrid learning environment may be a combination of a traditional classroom learning environment and a virtual learning environment, in which the student may only sometimes be in the same room as the teacher or responsibility party. In a hybrid learning environment, there may be one student computer 401 that is in the same physical location as responsible party computer 404, for example, in a classroom, and at least one other student computer 401 in a separate physical location from responsible party computer 404. For example, one student computer 401 may be in a classroom with responsible party computer 404, and a second student computer 401 may be in the student's home. Lessons 302 from ILP 111 may be completed in the classroom, at home, at another location with a student computer 401, or some combination thereof. For example, a problem set may be partially completed by a student on student computer 401 in the student's home, and then finished by the student on the student computer 401 in the classroom with responsible party computer. The student may not be expected to be in the classroom for a full day of instruction for every school day during the course of ILP 111.

ILP 111 may have lessons 302 requiring the teacher or responsible party to use responsible party computer 404 to provide lessons, instructions and/or assistance to the student when the student is outside of the classroom on school days when the student is not required to come to the classroom. For some lessons 302, the student may have the option of going to the classroom and completing the coursework on student computer 401 in the classroom, or not going to the classroom and completing the coursework on a different student computer 401.

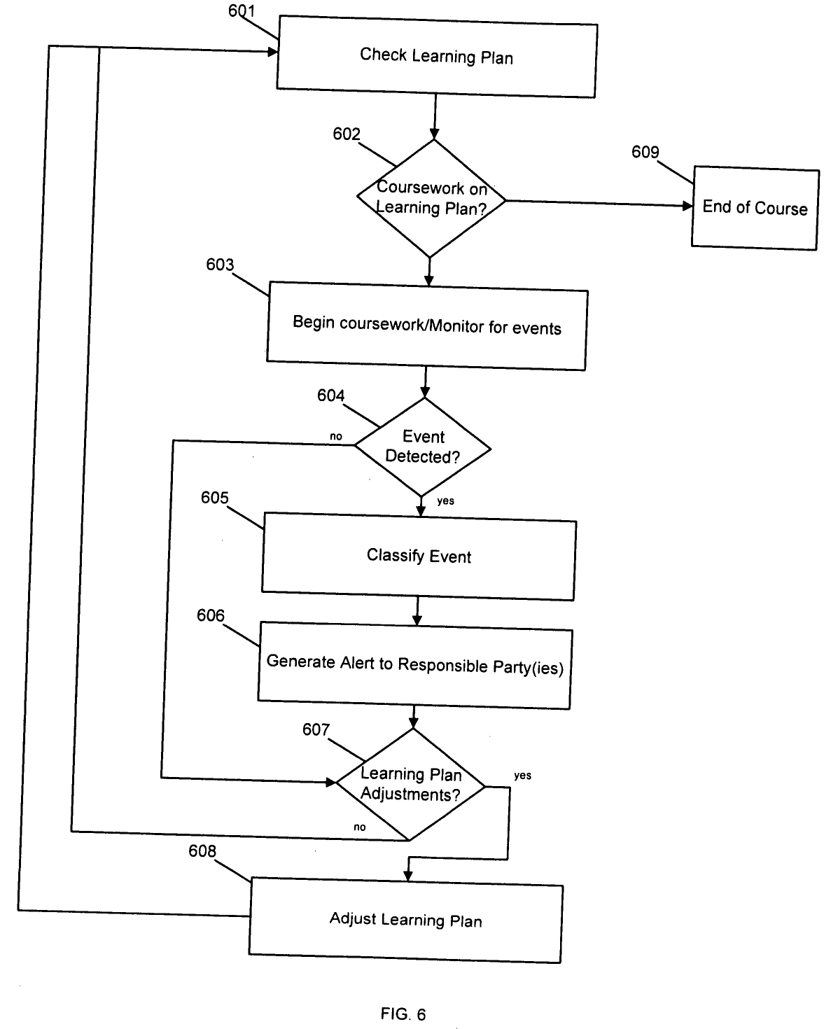

FIG. 6 depicts an exemplary flowchart for a method for teaching basal math and science. The method of FIG. 6 may be adapted for use in any of the above described learning environments. In block 601, ILP 111 may be checked for lessons 302. Checking ILP 111 may be performed by accessing ILP 111 in student records 405 on server 402 from student computer 401 and/or responsible party computer 404. Access to ILP 111 may be initiated by a user of student computer 401 or responsible party computer 404, or may be automatically performed by student computer 401 or responsible party computer 404. For example, logging into student computer 401 may cause ILP 111 to be checked automatically and any relevant lessons 302, for example, to be completed that day, may be displayed automatically on student computer 401. ILP 111 may be checked for lessons 302 designated to be assigned on the current day, at the current time.

For example, a student may be in a science course. Student records 405 for the student may contain subject area records 501 in the subject area of science. At 9 a.m. on Monday, Sep. 3, 2007, a science teacher may access ILP 111 in the science subject area records 501 for the student from responsible party computer 404.

In block 602, if the ILP 111 contains lessons 302 that have not been completed, flow proceeds to block 603. Otherwise, flow proceeds to block 609 and ends.

For example, when ILP 111 is checked by the science teacher, it may be found to contain lessons 303, scheduled to begin at 9:10 a.m., Sep. 3, 2007.

In block 603, one of the lessons 302 found on ILP 111 in block 601 may be begun and events may be monitored. The one of the lessons 302 may be performed by a student, teacher, or both, depending on the nature of the lesson. For example, a test may be completed by the student. As in most school settings, at any given time, a student may have several lessons in progress simultaneously, in various stages of completion. The flowchart of FIG. 6 illustrates a general sequence of beginning and completing one lesson from an ILP 111, however, it may be understood that each student may be engaged in several different lessons at the same time. Before a lesson is complete, event monitor 403 may monitor for events.

For example, the one of the lessons 302 of a lesson on gravity on ILP 111 may be begun at the time designated for the one of the lessons 302 on ILP 111, 9:10 a.m, Sep. 3, 2007. The lesson on gravity may be presented to the student by the teacher through any suitable means. For example, if the teacher and student are in a classroom, the teacher may use an interactive whiteboard to present the lesson to the student. The lesson may be an interactive lesson, and the student may use student computer 401 to interact with the interactive portions of the lesson. If the student is at home, the teacher may use responsible party computer 404, or an interactive whiteboard or other device, to present the lesson to the student on student computer 401, using, for example, an internet based audio-visual connection. ILP 111 may indicate that the lesson is to last for 1 hour. The teacher may attempt to finish the presentation of the lesson within the 1 hour indicated by ILP 111. Upon completion of the lesson, the teacher may indicate to ILP 111 that the lesson has been completed by, for example, accessing ILP 111 from responsible party computer 404 and entering input indicating the completion of the lesson. The end of the lesson may also be detected automatically by, for example, responsible party computer 404 and/or student computer 401.

As another example, ILP 111 may contain one of the lessons 302 that is a problem set on gravity, which may be designated as homework. ILP 111 may indicate that the problem set is to be assigned on Sep. 3, 2007, and has a due of Sep. 7, 2007. In this case, the student may begin work on the problem set on September 3, but may not finish the problem set until September 7. In the interim time, other lessons 302 from ILP 111 may be begun, and some of these lessons 302 may also be completed before the completion of the problem set on gravity. The student may complete the problem set on gravity at home, for example, using student computer 401, and may submit the completed problem set using student computer 401 at home or in the classroom. The completed problem set may be sent to server 402, where it may be graded and become stored in completed coursework 502 in subject area records 501 for the subject area of science, in student records 405 for the student.

In block 604, if an event is detected, flow proceeds block 605. Otherwise, flow proceeds to block 607. An event may be detected by event monitor 403.

For example, if the teacher presenting the lesson on gravity starts the lesson at the prescribed time of 9:10 a.m. on Sep. 3, 2007, but has not indicated that the lesson has been finished within 1 hour, event monitor 403 may detect that an event has occurred.

As another example, the student may turn in the problem set on gravity by the due date of Sep. 7, 2007, by submitting the completed problem set to server 402 from student computer 401. If the problem set receives a grade below a threshold set in event monitor 403, event monitor 403 may detect that an event has occurred.

In block 605, a detected event may be classified. Event monitor 403 may determine the type of event that has been detected and may determine the appropriate action to be taken. Events may be classified by any suitable criterion for distinguishing events, including, for example, whether an event is the occurrence of something or the failure of something to occur; whether an event is related to the student, teacher, or both; whether an event requires generation of an alert and to whom and how such an alert should be sent; whether an event requires adjustment of ILP 111; etc. For example, if event monitor 605 is programmed to only generate an alert to a student's parents if the student has failed to turn in one of the lessons 302 by a due date, event monitor 605 may determine if a detected event is the failure of the student to turn in one of the lessons 302 by the one of the lessons 302's due date.

For example, after event monitor 403 has detected that the teacher has not finished presenting the lesson on gravity started at 9:10 a.m. on September 3 by 10:10 am on September 3, event monitor 403 may classify the event. This event may be classified as being related to the teacher, occurring within the classroom, and being a failure to meet a due date.

As another example after event monitor 403 has detected that the problem set turned in by the student on September 7 has received a grade below a set threshold, event monitor 403 may classify the event. This event may be classified as being related to the student, location independent, and being a failure to meet a grade threshold.

In block 606, event monitor 403 may generate alerts to be sent to the appropriate responsible parties. The responsible parties to be alerted on the occurrence of an event may be determined in block 605 based on the nature of the event detected by event monitor 403. The events which event monitor 403 generates alerts in response to, and the parties to whom these alerts will be sent, may be determined by rules set within event monitor 403 that govern the operation of event monitor 403.

For example, after event monitor 403 detects and classifies the teacher failing to complete presentation of the lesson on gravity within the time allotted on ILP 111, event monitor 403 may generate an appropriate alert based on rules governing the operation of event monitor 403. The alert may be generated and sent to responsible party computer 404 as a pop-up message, indicating to the teacher that the due date for the lesson has been missed.

As another example, after event monitor 403 detects and classifies the student failing to achieve a grade above the threshold on the problem set, event monitor 403 may generate an appropriate alert. The alert may be generated and sent to responsible party computer 404 for the teacher and for the student's parents or guardian(s) as an email message.

In block 607, if ILP 111 is to be adjusted, flow proceeds to block 608. Otherwise, flow proceeds back to block 601.

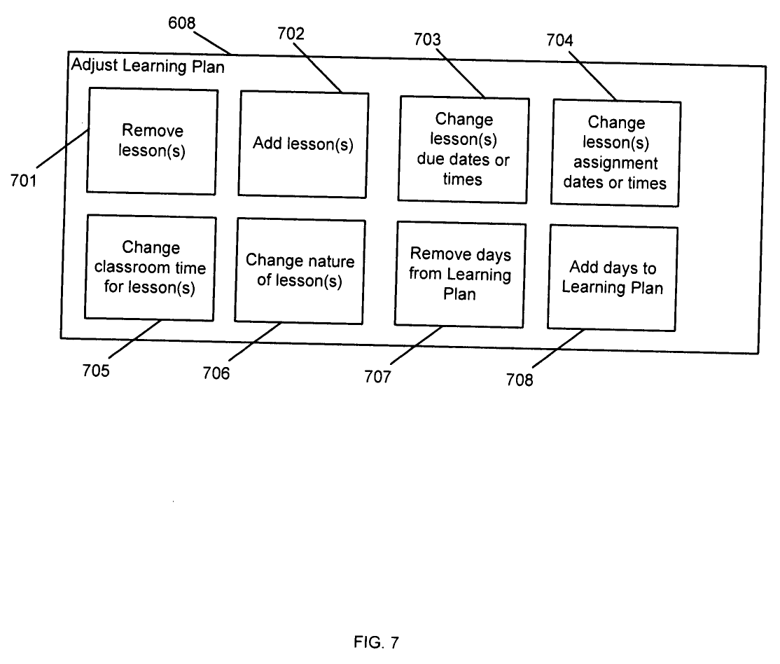

In block 608, adjustments to ILP 111 may be made. ILP 111 may be adjusted by a responsible party, for example a teacher using responsible party computer 404, by another party with permission to adjust ILP 111, for example, a student who has been granted permission to make changes to ILP 111 using student computer 401, or adjustments may be made automatically, for example, by event monitor 403. FIG. 7 depicts an exemplary set of adjustments that may be made to an ILP 111. In block 608, various operations may be performed including, for example: removing lessons, as in block 701; adding lessons, as in block 702; changing the due dates or times of lessons, as in block 703; changing the assignment dates or times of lessons, as in block 704; changing the length of time set aside to work on lessons in the classroom, as in block 705; changing the nature of lessons, as in block 706; removing days from ILP 111, as in block 707; and adding days to ILP 111, as in block 708.

In block 701, lessons 302 may be removed from ILP 111. Lessons 302 may be removed from ILP 111 by any party with permission to remove lessons 302 from ILP 111. For example, if ILP 111 is a math curriculum, a math teacher using responsible party computer 404 may access ILP 111 on server 402 and remove lessons 302 from ILP 111. Event monitor 403 may automatically remove lessons 302 from ILP 111 in response to a detected event.

In block 702, lessons 302 may be added to ILP 111. Lessons 302 may be added to ILP 111 any party with permission to add lessons 302 to ILP 111. For example, if ILP 111 is a math curriculum, a math teacher using responsible party computer 404 may access ILP 111 on server 402 and add lessons 302 to ILP 111. Lessons 302 added to ILP 111 may be selected from coursework database 112. Event monitor 403 may automatically add lessons 302 to ILP 111 in response to a detected event.

In block 703, the due dates or times of lessons 302 may be changed on ILP 111. The due dates or times of lessons 302 may be changed on ILP 111 by any party with permission to change the due dates and times of lessons 302. For example, if ILP 111 is a math curriculum, a math teacher using responsible party computer 404 may access ILP 111 on server 402 and change the due dates and times of lessons 302 on ILP 111. Event monitor 403 may automatically change the due dates and times of lessons 302 on ILP 111 in response to a detected event. The due dates and times of lessons 302 on ILP 111 may be changed, for example, to earlier dates or times that occur after date and time on which the change is made and after the assignment dates or times for lessons 302, or to later dates or times.

In block 704, the assignment dates or times of lessons 302 may be changed on ILP 111. The assignment dates or times of lessons 302 may be changed on ILP 111 by any party with permission to change the assignments dates and times of lessons 302. For example, if ILP 111 is a math curriculum, a math teacher using responsible party computer 404 may access ILP 111 on server 402 and change the assignment dates and times of lessons 302 on ILP 111. Event monitor 403 may automatically change the assignment dates and times of lessons 302 on ILP 111 in response to a detected event. The assignment dates and times of lessons 302 on ILP 111 may be changed, for example, to earlier dates or times that occur after date and time on which the change is made, or to later dates or times before the due dates and times of lessons 302.

In block 705, the amount of classroom time set aside to work on lessons 302 may be changed on ILP 111. The classroom time for lessons 302 may be changed on ILP 111 by any party with permission to change classroom time for lessons 302. For example, if ILP 111 is a math curriculum, a math teacher using responsible party computer 404 may access ILP 111 on server 402 and change the classroom time for lessons 302 on ILP 111. Event monitor 403 may automatically change the classroom time for lessons 302 on ILP 111 in response to a detected event. The classroom time for lessons 302 on ILP 111 may be changed, for example, by increasing the amount of classroom time for working on lessons 302, or by decreasing the amount of classroom time for working ion lessons 302.

In block 706, the nature of lessons 302 may be changed on ILP 111. The nature of lessons 302 may be changed on ILP 111 by any party with permission to change the nature of lessons 302. For example, if ILP 111 is a math curriculum, a math teacher using responsible party computer 404 may access ILP 111 on server 402 and change the nature of lessons 302 on ILP 111. Event monitor 403 may automatically change the nature of lessons 302 on ILP 111 in response to a detected event. The nature of lessons 302 on ILP 111 may be changed, for example, by changing a test into a problem set, changing classroom work into homework, changing a reading assignment into a lesson, changing graded lessons 302 into ungraded lessons 302, etc.

In block 707, days may be removed from ILP 111. Days may be removed from ILP 111 by any party with permission to remove days from ILP 111. For example, if ILP 111 is a math curriculum, a math teacher using responsible party computer 404 may access ILP 111 on server 402 and remove days from ILP 111. Event monitor 403 may automatically remove days from ILP 111 in response to a detected event. Days may be removed from ILP 111 by, for example, removing days from the end of ILP 111, because, for example, lessons 302 scheduled for the days at the end of ILP 111 were removed from ILP 111 or had their assignment dates and times changed to days earlier on ILP 111.

In block 708, days may be added to ILP 111. Days may be added to ILP 111 by any party with permission to add days to ILP 111. For example, if ILP 111 is a math curriculum, a math teacher using responsible party computer 404 may access ILP 111 on server 402 and add days to ILP 111. Event monitor 403 may automatically add days to ILP 111 in response to a detected event. Days may be added to ILP 111 by, for example, adding days to the end of ILP 111, because, for example, lessons 302 were added to ILP 111 and more days were needed to schedule them to avoid conflict with lessons 302 already on ILP 111, or coursework items 111 had their assignment dates and times or due dates and times changed to days after the end of ILP 111, necessitating additional days on ILP 111.

For example, in response to the event of the teacher failing to complete presentation of the lesson on gravity by the due date, event monitor 403 may automatically adjust ILP 111. Event monitor 403 may change the assignment dates and times and due dates and times for lessons 302 scheduled for after the lesson on gravity on ILP 111 in order to accommodate the amount of time past the due date the teacher will need to complete the lesson.

As another example, in response to receiving the alert indicating the student revived a grade below the threshold on the problem set on gravity, the teacher may use responsible party computer 404 to access ILP 111 for the student on server 402. The teacher may adjust ILP 111 by, for example, adding lessons 302 of an additional lesson on gravity and an additional problem set on gravity.

In block 609, the course ends. ILP 111 has no more coursework on it, indicating that the end of the course has been reached.

FIG. 8 depicts an exemplary embodiment of a system for accessing server 402. Student computer 401 and responsible party computer 404 may access ILP 111, lessons 302, and other items on server 402 through a network 804 using a user interface 806 of learning environment application 818, in order to facilitate completion of lessons 302 on ILP 111.

Learning environment application 81 8 may be a program or script or portion thereof, running on server 402. Learning environment application 818 may provide access to the ILP 111, the lessons 302, and other items on server 402 through various components of a user interface 806.

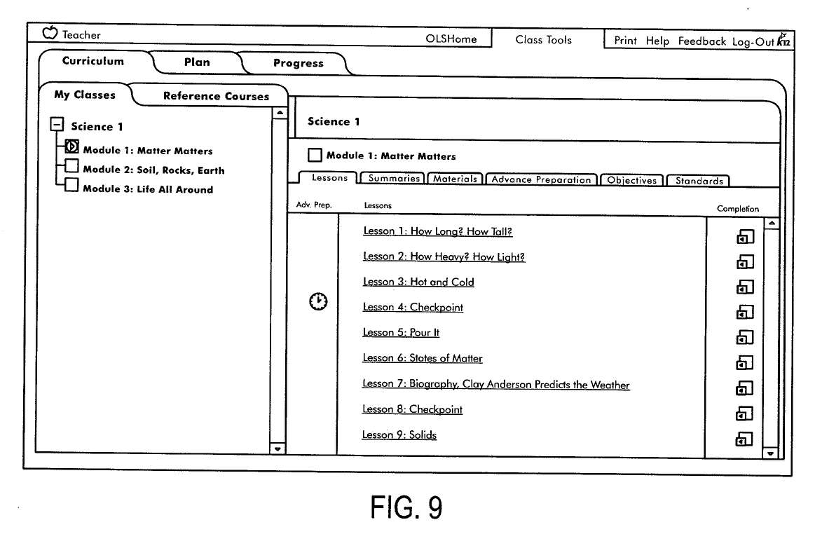

Curriculum planner 812 may be a component of learning environment application 818, and may provide one mode of online lesson access allowing a teacher direct access to a desired one of the lessons 302. Curriculum planner 812 may also provide information about advance preparation, objectives, and state standard alignments. For each of the lessons 302, the teacher may access information summarizing the lesson 302 and a list of materials, objectives, and state standard alignments for the lesson 302. Curriculum planner 812 may also be used for performing adjustments to ILP 111, as described above in FIG. 7. FIG. 9 depicts an exemplary display for curriculum planner 812.

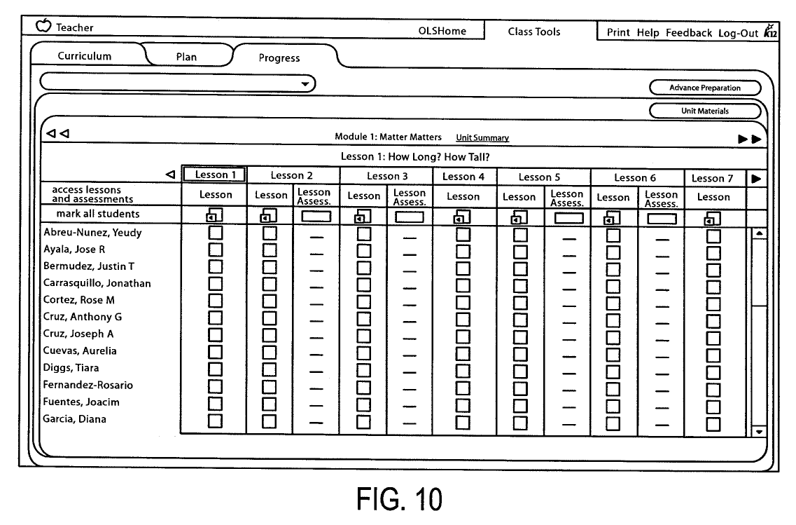

Progress tracker 816 may be a component of learning environment application 818, and may provide a range of online capabilities to help the teacher enter assessment scores and mark and track student and class progress. Student records 405 may be accessed through progress tracker 816, where the teacher or responsibly party may view completed coursework 502, including the lessons 302 that have been completed and placed in completed coursework 502 and the grades assigned to such lessons 302. The teacher or responsible party may use progress tracker 816 to view, enter, and change grades assigned to completed coursework 816. FIG. 10 depicts an exemplary display for progress tracker 816.

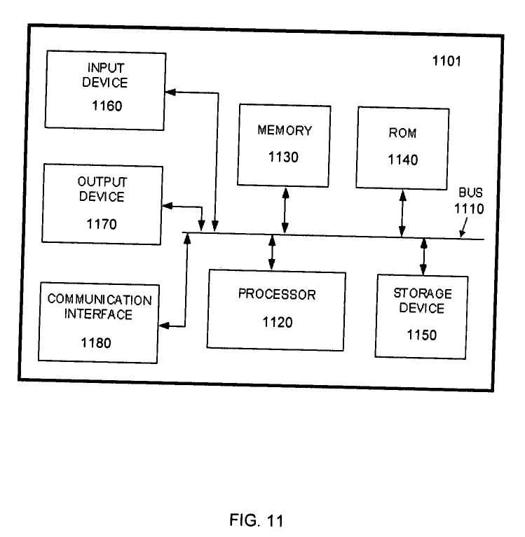

FIG. 11 illustrates an exemplary architecture for implementing a computing device 1101 that may be the student computer 401, responsible party computer 404, or server 402. It will be appreciated that other devices that can be used with the computing device 1101, such as a client or a server, may be similarly configured. As illustrated in FIG. 11, computing device 1101 may include a bus 1110, a processor 1120, a memory 1130, a read only memory (ROM) 1140, a storage device 1150, an input device 1160, an output device 1170, and a communication interface 1180.

Bus 1110 may include one or more interconnects that permit communication among the components of computing device 1101. Processor 1120 may include any type of processor, microprocessor, or processing logic that may interpret and execute instructions (e.g., a field programmable gate array (FPGA)). Processor 1120 may include a single device (e.g., a single core) and/or a group of devices (e.g., multi-core). Memory 1130 may include a random access memory (RAM) or another type of dynamic storage device that may store information and instructions for execution by processor 1120. Memory 1130 may also be used to store temporary variables or other intermediate information during execution of instructions by processor 1120.

ROM 1140 may include a ROM device and/or another type of static storage device that may store static information and instructions for processor 1120. Storage device 150 may include a magnetic disk and/or optical disk and its corresponding drive for storing information and/or instructions. Storage device 1150 may include a single storage device or multiple storage devices, such as multiple storage devices operating in parallel. Moreover, storage device 1150 may reside locally on the computing device 1101 and/or may be remote with respect to a server and connected thereto via network and/or another type of connection, such as a dedicated link or channel.

Input device 1160 may include any mechanism or combination of mechanisms that permit an operator to input information to computing device 1101, such as a keyboard, a mouse, a touch sensitive display device, a microphone, a pen-based pointing device, and/or a biometric input device, such as a voice recognition device and/or a finger print scanning device. Output device 1170 may include any mechanism or combination of mechanisms that outputs information to the operator, including a display, a printer, a speaker, etc.

Communication interface 1180 may include any transceiver-like mechanism that enables computing device 1101 to communicate with other devices and/or systems, such as a client, a server, a license manager, a vendor, etc. For example, communication interface 1180 may include one or more interfaces, such as a first interface coupled to a network and/or a second interface coupled to a license manager. Alternatively, communication interface 1180 may include other mechanisms (e.g., a wireless interface) for communicating via a network, such as a wireless network. In one implementation, communication interface 1180 may include logic to send code to a destination device, such as a target device that can include general purpose hardware (e.g., a personal computer form factor), dedicated hardware (e.g., a digital signal processing (DSP) device adapted to execute a compiled version of a model or a part of a model), etc.

Computing device 1101 may perform certain functions in response to processor 1120 executing software instructions contained in a computer-readable medium, such as memory 1130. In alternative embodiments, hardwired circuitry may be used in place of or in combination with software instructions to implement features consistent with principles of the invention. Thus, implementations consistent with principles of the invention are not limited to any specific combination of hardware circuitry and software.

Exemplary embodiments of the invention may be embodied in many different ways as a software component. For example, it may be a stand-alone software package, or it may be a software package incorporated as a “tool” in a larger software product, such as, for example. It may be downloadable from a network, for example, a website, as a stand-alone product or as an add-in package for installation in an existing software application. It may also be available as a client-server software application, or as a web-enabled software application.

While various exemplary embodiments have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A computer-implemented method for teaching basal math and science comprising:
testing a student with a computerized test to produce a completed test;
scoring the completed test on a computer to produce a score;
determining a grade level for the student based on the score;
generating a weak areas assessment for the student based on the completed test; and
generating a computer-based individualized learning plan based on the determined grade level, a curriculum, and the weak areas assessment.

2. The computer-implemented method of claim 1, further comprising:
providing computerized coursework based on the individualized learning plan.

3. The computer-implemented method of claim 2, further comprising:
monitoring the computerized coursework to detect events; and
at least one of:
generating alerts based on detected events, or
automatically modifying the individualized learning plan based on the detected events.

4. The computer-implemented method of claim 3, wherein monitoring to detect events comprises monitoring for at least one of:
a completed lesson, an over-due lesson, a low score, a high score, or a lesson completed before a due date.

5. The computer-implemented method of claim 2, wherein providing computerized coursework comprises providing computerized coursework in a classroom.

6. The computer-implemented method of claim 2, wherein providing computerized coursework comprises providing computerized coursework in a virtual learning environment.

7. The computer-implemented method of claim 2, wherein providing computerized coursework comprises providing computerized coursework a hybrid learning environment.

8. The computer-implemented method of claim 1, further comprising:
receiving modifications to the individualized learning plan from a user.

9. The computer-implemented method of claim 1, wherein the computerized test includes at least two sub-topics, and wherein scoring the computerized test to produce a score comprises scoring each sub-topic separately.

10. The computer-implemented method of claim 8, wherein generating a weak areas assessment comprises generating the weak areas assessment for each sub-topic based on a sub-topic score.

11. The computer-implemented method of claim 1, further comprising:
storing at least one of the completed test, the score, the grade level or the weak areas assessment on a computer-readable medium.

12. The computer-implemented method of claim 1, wherein generating a computer-based individualized learning plan comprises generating a computer-based individualized learning plan based on one of a math curriculum or a science curriculum.

13. A system for teaching basal math and science comprising:
a testing station to administer a computerized test and produce a completed test;
a scoring engine to receive the completed test and generate and transmit test results;
a test analyzing engine to receive the test results and generate and transmit a grade level and a weak areas assessment;
coursework database comprising a plurality of lessons; and
an individualized learning plan (ILP) generating engine to receive the grade level and the weak areas assessment, access the coursework database, and generate an ILP comprising a plurality of the lessons.

14. The system of claim 13, further comprising:
a server comprising student records, wherein the student records comprise an individualized learning plan;
a student computer adapted to access the server; and
a responsible party computer adapted to access the server.

15. The system of claim 14, wherein the server further comprises:
an event monitor adapted to monitor the individualized learning plan, the student computer, and the responsible party computer to detect events, and generate alerts based on detected events.

16. The system of claim 14, the server further comprising:
a learning environment application, including:
a curriculum planner to view and access lessons in the individualized learning plan;
a progress tracker to view and track at least one of a student or a class's progress through one or more individualized learning plans; and
a user interface to provide access to the curriculum planner and the progress tracker.

17. A computer-readable medium comprising instructions, which when executed by a computer system causes the computer system to perform operations for creating an individualized learning plan for a math or science curriculum, the medium comprising:
instructions for testing a student with a computerized test to produce a completed test;
instructions for scoring the completed test on a computer to produce a score;
instructions for determining a grade level for the student based on the score;
instructions for generating a weak areas assessment for the student based on the completed test; and
instructions for generating a computer-based individualized learning plan based on the determined grade level, a curriculum, and the weak areas assessment.

18. The computer-readable medium of claim 17, further comprising:
instructions for providing computerized coursework based on the individualized learning plan.

19. The computer-readable medium of claim 18, further comprising:
monitoring the computerized coursework to detect events; and
instructions for at least one of:
generating alerts based on detected events, or
automatically modifying the individualized learning plan based on the detected events.

20. The computer-readable medium of claim 19, wherein the instructions for monitoring to detect events comprise instructions for monitoring for at least one of:
a completed lesson, an over-due lesson, a low score, a high score, or a lesson completed before a due date.

21. The computer-readable medium of claim 18, wherein the instructions for providing computerized coursework comprise instructions for providing computerized coursework in at least one of a classroom, a virtual learning environment, or a hybrid learning environment.

22. The computer-readable medium of claim 17, further comprising:
instructions for receiving modifications to the individualized learning plan from a user.

23. The computer-readable medium of claim 17, wherein the computerized test includes at least two sub-topics, and wherein the instructions for scoring the computerized test to produce a score comprise instructions for scoring each sub-topic separately.

24. The computer-readable medium of claim 25, wherein the instructions for generating a weak areas assessment comprise instructions for generating the weak areas assessment for each sub-topic based on a sub-topic score.

25. The computer-readable medium of claim 17, further comprising:
instructions for storing at least one of the completed test, the score, the grade level or the weak areas assessment on a computer-readable medium.
